(19) United States
(12) Patent Application Publication
(10) Pub. No.: US 2009/0057010 A1
(43) Pub. Date: Mar. 5, 2009

(54) COVER FOR TERMINATED CABLES

(75) Inventors: Richard J. Scherer, Austin, TX (US); Michael L. Black, Austin, TX (US); Melanie G. Gover, Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/848,751

(22) Filed: Aug. 31, 2007

(51) Int. Cl. H02G 15/02

(52) U.S. Cl. 174/74 A

(57) ABSTRACT

A cover includes a flexible polymeric body defining a longitudinally extending space and having an outer surface, a first end defining an opening providing access to the space, a second end opposite to the first end, and an attachment segment positioned near the second end. The opening and the space are configured to receive an end portion of a terminated cable. The attachment segment is configured to receive a pulling member. The cover may be positioned over an end portion of a terminated cable and attached to a pulling member to draw the terminated cable through a passageway.

### TECHNICAL FIELD

The present invention relates to devices and methods used to grip and pull terminated cables through passageways.

### BACKGROUND

Electrical or fiber optic connectors and cables are commonly pulled through a passageway using fish tape. By careful manipulation, the fish tape can be “fished” (guided) through the passageway. Once guided through, the connector or cable can be pulled through the passageway by attaching it to the end of the fish tape and pulling the tape back from where it came.

Typically, the connector or cable is attached to the fish tape by wrapping electrical tape around the connector or cable end, which also protects the connector or cable end from dirt and debris, and the fish tape. A problem that occurs with this method is that the attachment point of the connector or cable to the fish tape often gets caught in bends or obstructions in the passageway and cannot be pulled through. In addition, this method is labor-intensive, time consuming, and can result in damage of the connector or cable end.

Another method of attaching a connector or cable to fish tape is by using an elongated braided gripping sleeve that contracts radially when tensioned, taking advantage of the “trellis effect”. This gripping sleeve is typically made of high strength but flexible filamentary members. These filamentary members are typically sharp and rough and, if uncovered, can snag, damage, or sever the connector or cable end or items within the passageway. In practice, electrical tape is wrapped around the connector or cable end before it is inserted in the gripping sleeve. After that, the gripping sleeve is covered with a layer of electrical tape. This method is labor-intensive and time consuming.

Another method of attaching a connector to fish tape is by using a mechanical coupler. The coupler attaches directly to the connector using the existing connector fastening screws which engage threaded holes in the coupler. A swivel attachment at the front of the coupler provides attachment for the fish tape. The coupler typically includes a curved and/or tapered leading front surface enabling the coupler to deflect around obstructions as it is moved through a passageway. A disadvantage of this method is that the design of the coupler is specific to the design of the connector.

Numerous devices and methods have been developed for pulling terminated cables through passageways. Although many of these devices and methods are useful, there is still a need in the art for a device and method for quickly and easily pulling terminated cables through passageways.

### SUMMARY

In one aspect, the present invention provides an article comprising a flexible polymeric body defining a longitudinally extending space and having an outer surface, a first end defining an opening providing access to the space, a second end opposite to the first end, and an attachment segment positioned near the second end. The opening and the space are configured to receive an end portion of a terminated cable. The attachment segment is configured to receive a pulling member.

In another aspect, the present invention provides an article comprising a terminated cable and a cover therefor. The cover includes a flexible polymeric body defining a longitudinally extending space and having an outer surface, a first end defining an opening providing access to the space, a second end opposite to the first end, and an attachment segment positioned near the second end. The opening and the space are configured to receive an end portion of a terminated cable. The attachment segment is configured to receive a pulling member. An end portion of the terminated cable is positioned in the space.

In another aspect, the present invention provides a method comprising providing a cover for a terminated cable and positioning the cover over an end portion of a terminated cable. The cover includes a flexible polymeric body defining a longitudinally extending space and having an outer surface, a first end defining an opening providing access to the space, a second end opposite to the first end, and an attachment segment positioned near the second end. The opening and the space are configured to receive an end portion of a terminated cable. The attachment segment is configured to receive a pulling member.

The above summary of the present invention is not intended to describe each disclosed embodiment or every implementation of the present invention. The Figures and detailed description that follow below more particularly exemplify illustrative embodiments.

### BRIEF DESCRIPTION OF THE DRAWINGS

FIG. 1 is a perspective view of an exemplary embodiment of a cover according to an aspect of the present invention connecting a terminated cable to a pulling member.

FIG. 2 is a perspective view of the cover of FIG. 1.

FIG. 3 is a perspective view of the cover of FIG. 1 partially positioned over a terminated cable.

FIG. 4 is a perspective view of the cover of FIG. 1 fully positioned over a terminated cable.

FIG. 5 is a perspective view of another exemplary embodiment of a cover according to an aspect of the present invention.

FIG. 6 is a perspective view of another exemplary embodiment of a cover according to an aspect of the present invention.

### DETAILED DESCRIPTION

In the following detailed description of the preferred embodiments, reference is made to the accompanying drawings that form a part hereof. The accompanying drawings show, by way of illustration, specific embodiments in which the invention may be practiced. It is to be understood that other embodiments may be utilized, and structural or logical changes may be made without departing from the scope of the present invention. The following detailed description, therefore, is not to be taken in a limiting sense, and the scope of the invention is defined by the appended claims.

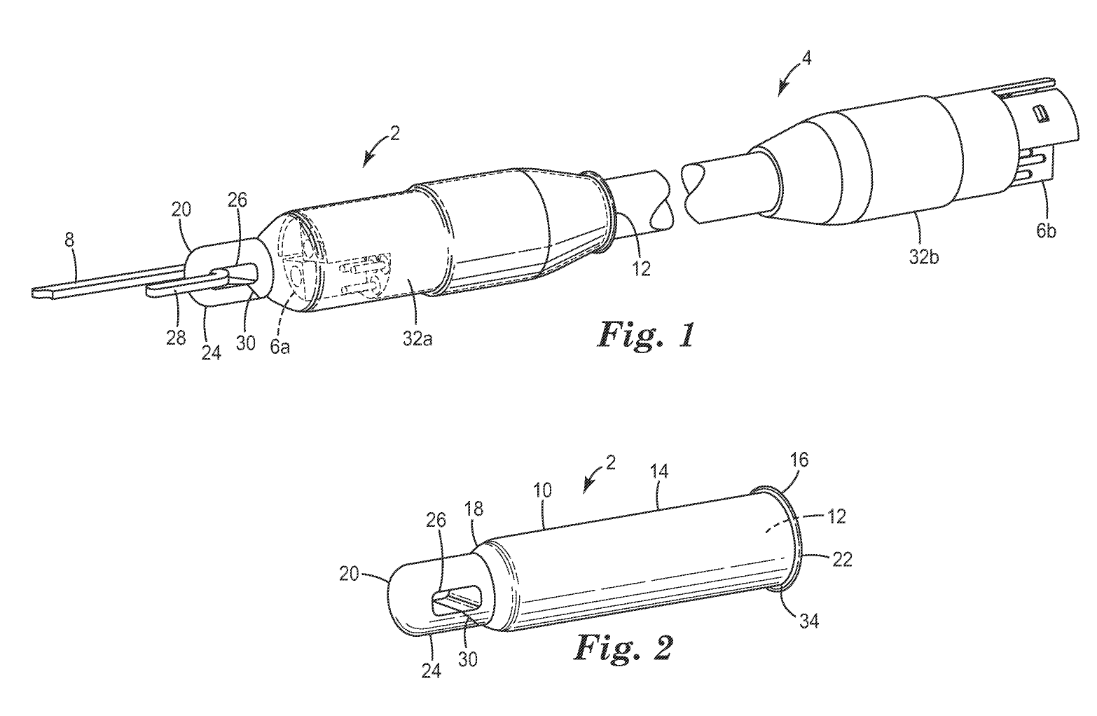

Now referring to the Figures, FIGS. 1-4 illustrate an exemplary embodiment of a cover according to an aspect of the present invention. In FIG. 1, cover 2 is fully positioned over an end portion 6a of a terminated cable 4, i.e., a cable with at least one connector attached, and connected to a pulling member 8 to provide a connection of terminated cable 4 to pulling member 8. This connection enables using pulling member 8 to draw terminated cable 4 through a passageway, such as, e.g., a wall cavity, a conduit, a channel, a duct, an opening, a cableway, or the like.

As best seen in FIG. 2, cover 2 includes a flexible polymeric body 10 defining a longitudinally extending space 12 and having an outer surface 14, a first end 16, a second end 18 opposite to first end 16, and an attachment segment 20 positioned near second end 18. First end 16 defines an opening 22 providing access to space 12. Opening 22 and space 12 are configured to receive end portion 6a of terminated cable 4, and attachment segment 20 is configured to receive pulling member 8. Pulling member 8 may be a pull cable, a string, fish tape, or other strong and flexible member, and may be attached to cover 2 by attaching it to attachment segment 20 in any suitable manner. To facilitate securing pulling member 8, attachment segment 20 of body 10 may have an aperture 26. For example, as can be seen in FIG. 1, pulling member 8 includes a hooked end that is simply hooked into aperture 26. Aperture 26 may have any suitable shape, such as, e.g., rectilinear or curvilinear. Attachment segment 20 of body 10 may include a slit 30 extending from aperture 26 to outer surface 14. Slit 30 may include a gap and is configured to receive pulling member 8. For example, if pulling member 8 does not include a hooked end, a loop may be formed on an end of pulling member 8 to be hooked through slit 30 into aperture 26 to secure pulling member 8 to cover 2. Additionally, body 10 may include a recess 24 adapted to facilitate securing pulling member 8. For example, in the embodiment of FIG. 2, recess 24 is defined by at least a portion of attachment segment 20 having a smaller perimeter than the remainder of body 10 and allows space for a tape, such as an electrical tape, to be wrapped around attachment segment 20 and attached pulling member 8, without extending beyond the perimeter of body 10. This helps to prevent pulling member 8 from causing the assembly to get caught when being pulled through a passageway. In one aspect, attachment segment 20 may be designed to release pulling member 8 if excessive forces are applied that could damage end portion 6a of terminated cable 4. For example, slit 30 may be designed to allow the release of pulling member 8.

In the embodiment of FIG. 1, terminated cable 4 includes an end portion 6a and an end portion 6b. End portion 6a of terminated cable 4 is positioned in space 12 of cover 2. In the embodiment of FIG. 1, end portion 6a includes an electrical connector 32a and end portion 6b includes in electrical connector 32b. In other embodiments, end portion 6a may include one or more cable ends (not shown), optionally folded over to increase the gripping surface, and/or one or more electrical connectors 32a. The one or more cable ends and/or the one or more connectors 32a may be bundled to be positioned in space 12 of a single cover 2. Terminated cable 4 may be an electrical terminated cable, including at least one electrical connector, or a fiber optic terminated cable, including at least one fiber optic connector, or a combination thereof. For example, terminated cable 4 may include a fiber optic cable and an electrical cable, and an end portion 6a including a fiber optic connector connected to the fiber optic cable and an electrical connector connected to the electrical cable. Exemplary embodiments of a terminated cable that can be used in an aspect of the present invention are shown and described in U.S. patent application Ser. No. 11/775,774 and U.S. patent application Ser. No. 29/247,987, both incorporated by reference herein in their entirety.

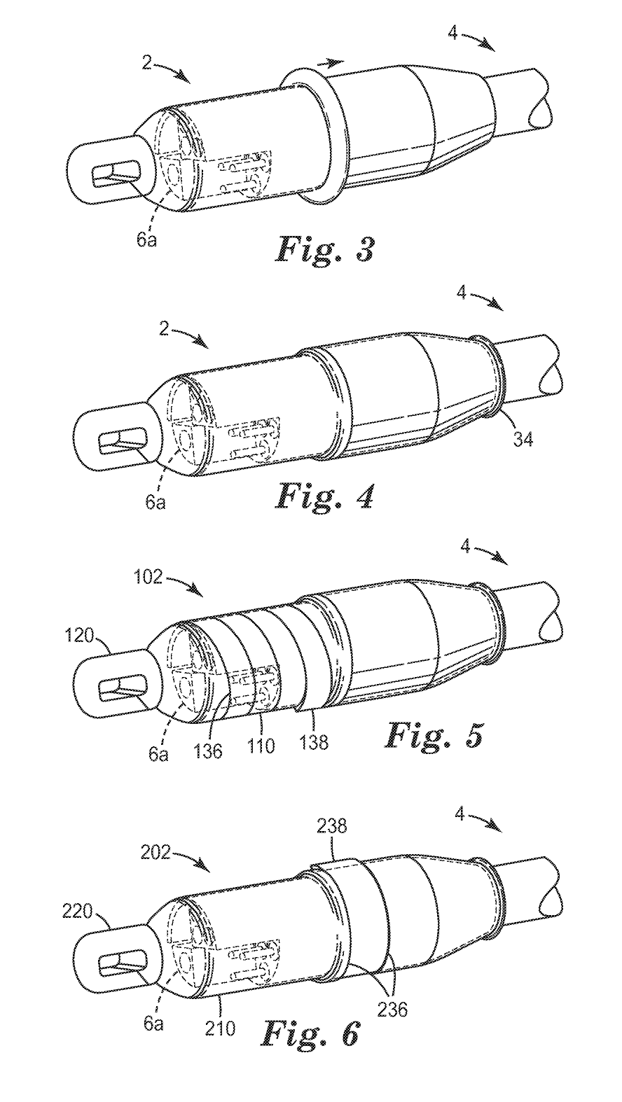

In the embodiment of FIGS. 1-4, cover 2 is positioned over end portion 6a of terminated cable 4. This may be accomplished by sliding or rolling cover 2 over end portion 6a. When rolling cover 2 over end portion 6a, cover 2 may be provided in a rolled up configuration, whereby second end 18 of body 10 may be positioned against the end of end portion 6a, after which cover 2 may be unrolled over end portion 6a, as shown in FIG. 3. Alternatively, cover 2 may be provided in an unrolled configuration, whereby a user may roll cover 2 up in a rolled up configuration prior to use. To enable this, cover 2 may include a rolling feature 34 at first end 16 of body 10 configured to initiate rolling of body 10. Rolling feature 34 may be any suitable feature that can initiate rolling of body 10, such as, e.g., a rim, an edge, a lip, or a thickened end. When sliding cover 2 over end portion 6a, cover 2 may be provided in an unrolled configuration (i.e., as shown in FIG. 2), whereby first end 16 of body 10 may be positioned over an end of end portion 6a, after which cover 2 may be slid over end portion 6a.

Body 10 of cover 2 may be formed of any suitable material, such as, e.g., a flexible polymeric material, by any suitable method, such as, e.g., injection molding, extrusion, casting, machining, or the like. One advantage of using a flexible polymeric material is that cover 2 may be easily positioned over end portion 6a of terminated cable 4 without damaging end portion 6a (e.g., a cable end, or connector 32a). Further, a flexible polymeric body enables cover 2 to be manufactured in a simple geometric shape (e.g., curvilinear, circular, rectilinear), that may elastically deform to take on the shape of end portion 6a during positioning cover 2 over end portion 6a, resulting in a precisely fitting cover that adequately protects end portion 6a and provides a streamlined, low friction outer surface 14 for drawing cover 2 and terminated cable 4 through a passageway. In addition, using a flexible polymeric material enables controlling the stiffness/flexibility in sections of cover 2 as is suited for the intended application. For example, it may be desired for attachment segment 20 to be designed relatively thick, so it will have a higher stiffness to enable a secure connection of pulling member 8 to cover 2. In contrast, it may be desired for body 10 around space 12 to be designed relatively thin, so it will have a higher flexibility to enable body 10 to take on the shape of end portion 6a during positioning cover 2 over end portion 6a. In one aspect, body 10 may be formed of a material comprising polyurethane, such as, e.g., a thermoplastic polyurethane elastomer. Advantages of this material include its compliancy and strength, allowing reuse of cover 2, and its chemical resistance, allowing cable pulling lubricants to be used. Examples of suitable thermoplastic polyurethane elastomers that may be used are those available under the trade names PEARLTHANE D11T70, PEARLTHANE D11T80, PEARLTHANE D15N70, from Merquinsa Mercados Químicos, S.L (Spain), or other PEARLTHANE materials.

To prepare for drawing pulling member 8, and thereby cover 2 and terminated cable 4, through a passageway, pulling member 8 may be attached to cover 2 before, during, or after the positioning of cover 2 over end portion 6a of terminated cable 4. For example, pulling member may be attached to cover 2 when cover 2 is fully positioned over end portion 6a of terminated cable 4, as shown in FIG. 4. Optionally, cover 2 may be lubricated to facilitate passage through the passageway. Cover 2 may be lubricated with any suitable lubricant, such as, e.g., polywater or other silicone based lubricants. Optionally, body 10 of cover 2 may include a plurality of protrusions (not shown) extending from outer surface 14. The plurality of protrusions may be designed to reduce the portion of outer surface 14 that makes contact with an inner surface of a passageway, thereby reducing the frictional resistance during the pulling operation. The shape and size of the protrusions may be chosen as is suited for the intended application. For example, in one application, the protrusions may have a dome shape.

After drawing pulling member 8, and thereby cover 2 and terminated cable 4, through a passageway, pulling member 8 may be removed from cover 2 and at least a portion of cover 2 may be removed from terminated cable 4. Pulling member 8 may be removed from cover 2 in any suitable manner. For example, if a loop was formed on an end of pulling member 8 and hooked through slit 30 into aperture 26 of attachment segment 20 to secure pulling member 8 to cover 2, pulling member 8 may simply be unhooked from attachment segment 20 by pulling it through slit 30. At least a portion of cover 2 may be removed from terminated cable 4 in any suitable manner, such as, e.g., by rolling, sliding, or stripping it from end portion 6a. To facilitate rolling at least a portion of cover 2 from end portion 6a, cover 2 may include rolling feature 34 at first end 16 of body 10 configured to initiate rolling of body 10 (as described above).

FIGS. 5 and 6 illustrate other exemplary embodiments of a cover according to an aspect of the present invention, wherein the body includes at least one score configured to facilitate removal of at least a portion of the body. In one aspect, a portion of the body may not be removed but remain on terminated cable 4 to serve as a cable grommet for terminated cable 4. Using a portion of the body as a cable grommet for terminated cable 4 may provide strain relief to the cable to prevent a tug on the cable from pulling on any electrical connections made with the cable.

In the exemplary embodiment of FIG. 5, cover 102 includes a body 110 having an attachment segment 120 and a score 136 extending spirally along body 110. Body 110 includes a tear initiating feature 138 positioned at one end of score 136 to initiate tearing of body 110 along score 136, thereby removing at least a portion of body 110 from end portion 6a of terminated cable 4. Tear initiating feature 138 may be any suitable feature that can initiate tearing of body 110, such as, e.g., a rim, an edge, a lip, a slit, or a thickened section. As described above, a portion of body 110 may remain on terminated cable 4 to serve as a cable grommet.

In the exemplary embodiment of FIG. 6, cover 202 includes a body 210 having an attachment segment 220 and two scores 236 extending radially along body 210. Body 210 includes a tear initiating feature 238 positioned in between scores 236 to initiate tearing of body 110 along scores 236, thereby removing the portion of body 110 positioned in between scores 236 from end portion 6a of terminated cable 4. Tear initiating feature 238 may be any suitable feature that can initiate tearing of body 210, such as, e.g., a rim, an edge, a lip, a slit, or a thickened section. By simply pulling on attachment segment 220, a second portion of body 210 may be removed from end portion 6a of terminated cable 4. As described above, a portion of body 210 may remain on terminated cable 4 to serve as a cable grommet.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the mechanical, electro-mechanical, and electrical arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. An article comprising:
a flexible polymeric body defining a longitudinally extending space and having an outer surface, a first end defining an opening providing access to the space, a second end opposite to the first end, and an attachment segment positioned near the second end,
wherein the opening and the space are configured to receive an end portion of a terminated cable and wherein the attachment segment is configured to receive a pulling member.

2. The article of claim 1, wherein the body comprises a recess adapted to facilitate securing the pulling member.

3. The article of claim 1, wherein the body comprises an aperture adapted to facilitate securing the pulling member.

4. The article of claim 3, wherein the body further comprises a slit extending from the aperture to the outer surface and configured to receive a pulling member.

5. The article of claim 1, wherein the body further comprises a rolling feature at the first end configured to initiate rolling of the body.

6. The article of claim 1, wherein the body further comprises at least one score configured to facilitate removal of at least a portion of the body.

7. The article of claim 6, wherein the at least one score extends spirally along the body.

8. The article of claim 6, wherein the at least one score extends radially along the body.

9. The article of claim 1, wherein the body further comprises a plurality of protrusions extending from the outer surface.

10. The article of claim 1, wherein the body is formed of a material comprising polyurethane.

11. The article of claim 10, wherein the material is a thermoplastic polyurethane elastomer.

12. An article comprising:
a cover for a terminated cable comprising:
a flexible polymeric body defining a longitudinally extending space and having an outer surface, a first end defining an opening providing access to the space, a second end opposite to the first end, and an attachment segment positioned near the second end,
wherein the opening and the space are configured to receive an end portion of a terminated cable and wherein the attachment segment is configured to receive a pulling member; and
a terminated cable, an end portion of which is positioned in the space.

13. The article of claim 12 further comprising a pulling member connected to the attachment segment and configured to pull the terminated cable through a passageway.

14. The article of claim 13, wherein the pulling member is one of a pull cable, a string, and fish tape.

15. The article of claim 12, wherein the terminated cable comprises at least one of an electrical connector and a fiber optic connector.

16. A method comprising:
providing a cover for a terminated cable comprising:
a flexible polymeric body defining a longitudinally extending space and having an outer surface, a first end defining an opening providing access to the space, a second end opposite to the first end, and an attachment segment positioned near the second end,
wherein the opening and the space are configured to receive an end portion of a terminated cable and wherein the attachment segment is configured to receive a pulling member; and
positioning the cover over an end portion of a terminated cable.

17. The method of claim 16, wherein positioning the cover comprises one of rolling and sliding.

18. The method of claim 16 further comprising attaching a pulling member to the attachment segment.

19. The method of claim 16 further comprising drawing the pulling member, and thereby the cover and the terminated cable, through a passageway.

20. The method of claim 19 further comprising lubricating the cover to facilitate passage through the passageway.

21. The method of claim 16 further comprising removing at least a portion of the cover from an end portion of the terminated cable.

22. The method of claim 21, wherein removing at least a portion of the cover comprises one of rolling, sliding, and stripping.
